(19) United States
(12) Patent Application Publication
(10) Pub. No.: US 2024/0188766 A1
(43) Pub. Date: Jun. 13, 2024

(54) COMPRESSING AND SHREDDING DEVICE

(71) Applicant: Alphatrend AG, Zug (CH)

(72) Inventors: Hans Keller, Aathal-Seegräben (CH); Edwin GRÜBEL, Widnau (CH)

(21) Appl. No.: 18/554,674

(22) PCT Filed: Apr. 11, 2022
(86) PCT No.: PCT/EP2022/059643

§ 371 Date: Dec. 14, 2023

(30) Foreign Application Priority Data
Apr. 12, 2021 (CH) 03377/21

(51) Int. Cl. A47K 10/46; B02C 18/00; B02C 18/14; B02C 18/22; B65F 1/14; B65F 7/00

(52) U.S. Cl. CPC A47K 10/46; B02C 18/0084; B02C 18/142; B02C 18/2233; B65F 1/1405; B65F 7/00; B65F 2210/168; B65F 2210/169

(57) ABSTRACT

A compressing and shredding device (100) for integration in a hygiene station (10) for human hand hygiene, which device is designed for compressing and shredding hand towels, in particular used and damp disposable cellulose cloths. The compressing and shredding device (100) includes: at least one receiving container (102) with a feed opening (112) and an interior (114) for receiving compressed and shredded hand towels; at least one compressing and/or shredding unit (104) for compressing and shredding hand towels, which is arranged at the feed opening (112) of the receiving container (102); and at least one drive unit (106) for driving the compressing and/or shredding unit (104).

### CROSS-REFERENCE TO RELATED APPLICATIONS

The present application is a 371 National Phase of PCT/EP2022/059643, filed Apr. 11, 2022, which claims priority from Swiss Patent Application No. 00377/21, filed Apr. 12, 2021, both of which are incorporated herein by reference as if fully set forth.

### TECHNICAL FIELD

The present invention relates to a compressing and shredding device for integration in a hygiene station for human hand hygiene.

### BACKGROUND

It is known in practice that, in particular at public toilet facilities, such as at rest areas, in addition to hot air hand dryers, dispensing devices for hand towels, usually disposable cellulose cloths, are available for customers to be able to dry their hands after washing their hands. A distinction should be made between dispensing devices which provide individual compacted hand towels, i.e. folded or folded-up hand towels, and those devices which provide hand towels in the form of continuous rolls. In the case of the latter, the hand towels have to be separated by the user, either by severing them at a prepared tear-off line, as a result of which the hand towel area is predetermined, or at the user's discretion, i.e. to the size which the user considers necessary to be able to sufficiently dry their hands. It should also be observed that a majority of users use or have to use more than one of the provided hand towels for a hand drying process in order to achieve an adequate drying result. After drying of the hands, the used hand towel or the used hand towels are only slightly manually compressed by the user for disposal, which means that they take up a large amount of space in the designated disposal or receiving container. This has the result that all too often the receiving containers overflow during the interval between the specified emptying operations, and the used hand towels fall out, and this also dirties or even contaminates the surroundings of the receiving container. Hand towels are understood as meaning paper hand towels.

DE 2 307 194 A1 discloses an apparatus having a paint funnel and a paint cone, which apparatus shreds paper and transports the residues through a suction line into a separator or another corresponding end station.

Furthermore, DE 20 2007 000 842 U1 discloses a washing installation having a wash basin, with a hand towel dispenser for dispensing hand towels and with a hand towel disposal device. The disposal device of the washing installation is equipped with a hand towel shredder. A collecting arrangement which can be flooded with liquid is provided below the shredding device and the collecting arrangement is connected to a drainage device for waste water.

WO 00/18284 A1 discloses a hand washing and drying device having a washing and drying chamber which has at least one access opening which provides access for introducing at least one hand to be washed, and a washing fluid dispenser fluidically connected to the interior of the washing and drying chamber for dispensing washing fluid within the washing and drying chamber. Furthermore, the hand washing and drying device comprises a blower dryer fluidically connected to the interior of the washing and drying chamber for providing a directed supply of drying air within the washing and drying chamber and a hand towel dispenser connected to the interior of the washing and drying chamber for dispensing a hand towel, e.g. a disposable paper hand towel, inside the chamber. Furthermore, the hand washing and drying device comprises a waste disposal unit for shredding a used hand towel, which is dispensed from the hand towel dispenser, and for discharging the shredded waste through a drain.

DE 203 10 218 U1 discloses a waste collector which has at least one attachment which can be attached releasably to the housing and comprises a paper shredder function.

The above-mentioned devices for compressing and/or shredding paper towels are either highly complex in their construction and/or unsuitable for a compact, modular design. In addition, either an additional connection to a suction or drainage line is necessary or the compressing and shredding result is insufficient.

### SUMMARY

It is therefore the object of the present invention to advantageously develop a device of the type mentioned above, in particular to the effect that a compact design for integrating the device in a hygiene station and a high compressing and shredding performance are made possible without having to dispense with safety aspects.

This object is achieved by a device having one or more of the features disclosed herein. Advantageous developments of the inventive subject matter are described below and in the claims.

According to the invention, a compressing and shredding device for integration in a hygiene station for human hand hygiene is provided, which device is designed for compressing and shredding hand towels, in particular used and damp disposable cellulose cloths. The compressing and shredding device comprises:
at least one receiving container with a feed opening and an interior for receiving compressed and shredded hand towels;
at least one compressing and/or shredding unit for compressing and shredding hand towels, which is arranged at the feed opening of the receiving container; and
at least one drive unit for driving the compressing and/or shredding unit.

The invention is based on the basic concept that hand towels for drying the hands, in particular disposable cellulose cloths, are advantageously processed by the compressing and shredding device in such a manner that the receiving range of the disposal or receiving container is extended by compressing and shredding used and damp disposable hand towels, as a result of which, inter alia, an overflowing receiving container is also avoided. It also follows from extending the receiving range of the receiving container that the interval between two emptying operations is also extended.

The compressing and/or shredding unit is designed here in such a manner that it can compress and/or shred dry, wet and/or semi-wet or damp, but also soiled (paper) hand towels.

In particular, the hygiene station does not have a supply line and a drain. Rather, it is a self-contained station, with the only exception that a power connection may be present for driving the compressing and/or shredding unit.

The receiving container is preferably cuboidal or has an approximately cube-like shape, but may also have a different shape, such as a cylindrical shape. The receiving container has a feed opening on its top side, wherein the feed opening may also comprise the entire area of the top side of the receiving container. The receiving container can be manufactured from plastic and/or a rust-free metal, and therefore the used hand towels which are introduced or fed in and which have a certain moisture content do not affect the surface of the interior of the receiving container.

The compressing and/or shredding unit is arranged in the region of the feed opening. The unit can either be located completely above the feed opening or can at least partially protrude therein. However, it is also conceivable that the compressing and/or shredding unit is completely arranged within the receiving container, as a result of which, however, the receiving volume of the container is reduced.

The compressing and/or shredding unit is driven by at least one drive unit, the driving torques of which are transferred to all the elements to be moved for compressing and shredding purposes. However, a plurality of drive units may also be provided, which drive different elements to be moved of the compressing and/or shredding unit.

The compressing and shredding device according to the invention is provided as part of a hygiene station for human hand hygiene, which in addition comprises a hand towel dispensing device, a disinfectant dispensing device and optionally a display and input device and a room fragrance emission device.

Such a hygiene station can be mounted on a wall, with the hygiene station being electrically supplied directly via the building power supply. The hygiene station may also be designed, however, as a mobile hygiene station, i.e. free-standing, and then has a sufficiently long electrical line, such as a power cable, with which it can be connected to a power supply or a generator.

The disinfectant dispensing device is arranged below the hand towel dispensing device such that disinfectant can be dispensed into a user's hands held under the disinfectant dispensing device.

The display and input device is arranged at approximately eye level of a user on the front side, i.e. on the outer surface opposite the installation side of the hygiene station. The display and input device can display e.g. advertising or a proposal for carrying out the hand hygiene to a user for the duration of their hand hygiene. In addition, provision may be made for the user to be able to use the display and input device, for example, for portioning the amount of disinfectant dispensed by the disinfectant dispensing device and/or for specifying the number of hand towels dispensed by the hand towel dispensing device for drying their hands. Furthermore, it is conceivable for the user to use the display and input device, for example, to enter an evaluation of their satisfaction regarding the state and the equipment of the sanitary facility, in the surroundings of which the hygiene station is set up or is mounted.

The room fragrance emission device can be arranged above the hand towel dispensing device such that it can supply or fill the site at which the hygiene station is set up with a room fragrance filling the room as far as possible. The room fragrance emission can be carried out either at specified intervals or via a sensor which is assigned to the room fragrance emission device and senses the number of users and/or their length of stay in the surroundings of the hygiene station and, depending thereon, adjusts the room fragrance emission.

The compressing and/or shredding device according to the invention into which the user can throw or feed used hand towels can be arranged below the disinfectant dispensing device.

The housing of the hand towel dispensing device is preferably located between the disinfectant dispensing device and the room fragrance emission device, wherein the dispensing opening of the hand towel dispensing device is arranged level with the dispensing of the disinfectant dispensing device and opposite the insertion opening of the compressing and/or shredding device.

The compressing and/or shredding unit has at least two counter-rotating rollers arranged parallel to one another.

The counter-rotating rollers or rolls arranged parallel to one another rotate in such a way that a used hand towel thrown in or introduced from the outside or from above is conveyed between the rollers into the interior of the receiving container.

The rollers are preferably identical in length and have the same diameter. However, it is also possible for the diameter of the two rollers to differ.

The rollers are manufactured from a material which is rigid or difficult to deform, such as stainless steel or ceramic.

In addition, it may be provided that the rollers have a multiplicity of revolving rings and/or grooves and/or nubs.

The rings or also, however, the grooves and/or nubs of a roller can be machined, as a result of which rings and roller consist of one workpiece.

However, the rings can also be pushed onto the roller and fastened at a predetermined position along the longitudinal axis of the roller. In the case of separate rings, they can be either made of the same material as the roller or of a different material.

Preferably, the rings have the same diameter.

In one possible exemplary embodiment, the rings are arranged uniformly and spaced equidistantly apart.

In order to achieve an optimum compressing and shredding performance along the entire longitudinal extent of the rollers, the rings are spaced equidistantly apart along the longitudinal axis of the rollers.

However, it is also conceivable for the rings to be at a smaller distance in a central portion of the rollers, provided that the configuration of the feed region of the compressing and shredding device means that there is an increased probability that the used and fed-in hand towels first reach the rollers in precisely this region.

In another possible exemplary embodiment, the rings are integrally formed on the respective roller.

This has the advantage that the rollers along their circumference have no point of weakness, which could yield in the course of the compressing and shredding operation.

It can also be provided that the rings of the rollers are arranged in such a manner that in each case one ring of one roller is opposite a gap between two rings of the other roller.

This ensures that there are no larger gaps along the longitudinal axis of the rollers, through which larger sections of the used hand towels are conveyed.

It may also be provided that the rings of the rollers intermesh.

The arrangement of the rings in the gaps between the rings of the respective other roller ensures an optimum compressing and shredding performance. The rollers are arranged in the gaps in such a manner that they do not touch either the roller body of the opposite roller or the rings thereof, which prevents wear of the rollers and rings.

The engagement depth of the rollers in the gaps between the rings of the opposite roller can be adjustable in order to be adapted to the composition of the provided hand towels, so as to ensure that there is no blockage of the rollers during the compressing and shredding operation.

In one possible exemplary embodiment, the rollers have circular blades arranged on the outer circumference.

The round blades or cutting edges on the outer circumference of the rings improve the shredding result of the used hand towels to be shredded.

Furthermore, provision may be made for the device to have a cover element with a releasable and reclosable insertion opening, and wherein the cover element covers the feed opening of the collecting container and accommodates the compressing and/or shredding unit.

The cover element prevents inadvertent reaching into the compressing and/or shredding unit, especially by children. This means that a used hand towel can only be fed in when the insertion opening has been released. At the same time, the cover element prevents overflowing of shredded hand towels, provided that the compressing and/or shredding unit does not fill the entire feed opening of the container.

At least one displaceable or foldable lid element can be provided on the top side of the cover element on the inside or outside for releasing and reclosing the insertion opening. This at least one lid element is movable via an additional drive unit. In the case of a displaceable lid element, the latter is guided on two sides in rails, along which it can release and reclose the insertion opening.

The lid element preferably comprises louvers which are pivotably connected to adjacent louvers on longitudinal sides and guided in rails on narrow sides. In a particularly advantageous embodiment, the rails extend in a first region at the insertion opening in a direction which forms an angle of less than 45° with respect to a horizontal plane, wherein in particular lower ends of the rails face the position of a person using the hygiene station. In a second region of the rails, the latter preferably extend in a direction which forms an angle of less than 15°, in particular 0°, with respect to a vertical plane. The two regions of each rail are connected to each other via a region of curvature. When the insertion opening is closed, the louvers are located in the first region of the rails and, when the insertion opening is released, said louvers are located in the second region. By using louvers and rails with the two described regions, the extent of the cover element required for the closing and opening can be kept small, in particular so as to be only slightly larger than the insertion opening. This allows the horizontal space required by the hygiene station to be kept small.

The cover element and the receiving container preferably have the same shape along the contacting edges, wherein the cover element rests on the receiving container in the region of the feed opening thereof such that the interior is sealed or substantially enclosed.

However, the cover element can also be pushed on in the region of the feed opening of the receiving container along two rails provided there, wherein the pushed-on cover element can be locked or can be arrested in its position over the feed opening of the receiving container.

In another possible exemplary embodiment, the cover element has a funnel element which is arranged below the insertion opening and is configured such that it conducts hand towels which are introduced to the compressing and/or shredding unit.

This has the advantage that used hand towels are fed to the compressing and/or shredding unit in such a way that no hand towels can pass into a dead region below the insertion opening of the cover element or can even pass uncompressed and unshredded into the receiving container, provided that the compressing and/or shredding unit does not fill the entire feed opening of the receiving container.

Furthermore, cleaning elements can be provided in each case on that side of the compressing and/or shredding unit which faces the interior of the receiving container, the cleaning elements freeing the compressing and/or shredding unit from adhering residues of the hand towels.

The cleaning elements can be strips which extend along the longitudinal axis of the rollers and are arranged at a small distance below the rollers in such a way that they strip off or remove residues of the compressed and reduced hand towels adhering to the rollers from the rollers. These strips are aligned in such a way that the stripped-off or removed residues can also pass into the receiving container. The strips can be made of plastic or metal or another suitable material.

In another possible exemplary embodiment, the device comprises a sensor and a controller which is connected to the sensor and controls the releasing and reclosing of the insertion opening.

The sensor senses that a used hand towel is intended to be fed in and transmits the sensed feed-in desire to the controller, which then activates the drive unit of the lid element such that the insertion opening can be released. After the used hand towel or the used hand towels have been introduced or thrown in by the user, the controller reactivates the drive unit of the lid element to close the insertion opening again. The controller is configured such that it releases the insertion opening either for a certain opening time or until it receives another signal from the sensor.

It may also be provided that the sensor is arranged on an outer surface of the device.

This allows movements and/or an input of a user with their hand and/or foot to be sensed in order to then release the insertion opening. It is therefore possible to provide a contact-free or a touch-sensitive sensor. However, it is also possible to provide more than one sensor, preferably two different types of sensor, in order firstly to provide the user with more than one option for releasing the insertion opening and secondly to provide redundancy in the event of the failure of a sensor.

The sensor may be provided as an optical sensor.

An optical sensor, such as a light sensor or optical detector, is a simple variant for detecting a user's desire to throw in a used hand towel and for transmitting said desire to the controller. In addition, however, a light barrier can also be implemented as an optical sensor, which light barrier, when the light beam is interrupted, transmits an electrical signal to the controller and sends a further signal to the controller as soon as the light barrier receiver receives the light beam again.

The hand towels which pass through the insertion opening to the compressing and/or shredding unit may have very different shapes. They may hardly be deformed and thus be substantially flat or shaped into a compressed ball of paper. They may also be completely dry to dripping wet in terms of their moisture content. Tests have shown that these great differences also lead to a very different entry behavior into the compressing and/or shredding unit and to different degrees of soiling of the compressing and/or shredding unit, or to impairments of the function thereof.

In a particularly advantageous compressing and shredding device, the compressing and/or shredding unit is assigned a pressing device, which is movable by a pressing drive unit between two end positions at a differing distance from the compressing and/or shredding unit. The pressing device makes it possible for hand towels to be pushed onto the compressing and/or shredding unit. This pressing is important for particularly dry, ball-shaped or flat hand towels because, despite the rotating rollers, said hand towels, if they are not pressed, do not pass between the rollers. The pressing device is important for trouble-free operation of the compressing and shredding device.

In a further particularly advantageous compressing and shredding device, the rollers comprise a multiplicity of revolving, radially projecting rings, wherein the rings are arranged on the rollers or formed in such a way that in each case a ring of a roller engages in a clearance next to a ring of the other roller. The directly adjoining rings of two interacting rollers overlap such that the mutually assigned edges of the rings cut material of the hand towels in the overlapping region.

Between the protruding peripheral surfaces of the rings and those regions of the rollers lying opposite said peripheral surfaces, a distance is or clearances are formed in which material of the hand towels is conveyed between the rollers toward the receiving container. To ensure that material of the hand towels is readily drawn into the clearances and conveyed through them toward the receiving container and compacted in the receiving container when the latter is already loosely filled, the rings have a rough surface radially on the outside. Preferably, the rough surface is in the form of a knurling. An advantageous knurling comprises furrows, which extend along the axes of the rollers. The rough surface or the knurling ensures that dry and wet, ball-shaped or flat hand towels are drawn into the compressing and/or shredding unit when in good contact with the inlet region of the rollers and that the shredded material of the hand towels is also conveyed into the receiving container counter to a large resistance.

In a preferred embodiment, the filling level of the receiving container is displayed. This allows the service personnel to empty the receiver container promptly. The filling level can optionally be displayed via a viewing window. Since the shredded material of the hand towels even in the loose state may substantially fill the entire receiving container, information dependent on the overall density of the material in the receiving container is preferably displayed as the filling level. Accordingly, the maximum filling level is assigned to a maximum permissible material density in the receiving container. In a particularly advantageous embodiment, at least one pressure or force sensing device is arranged on the receiving container, which device makes it possible to sense and in particular to display the filling level.

For example, a force absorbed corresponding to the filling level or the pressure in the receiving container by a border partial area of the receiving container can be sensed and displayed. For this purpose, for example, a pressure sensed at the border partial area, or a deformation of the border area or the deflection of the border partial area caused counter to a preload is sensed. Preferably, at least one pressure sensor is arranged on the receiving container. It is advantageous if a pressure sensor is arranged at least on a partial area of the base of the receiving container. Optionally, the at least one pressure sensor is arranged on a wall of the receiving container or optionally at the shredding unit, for example in the vicinity of the rollers.

The filling level sensed by the pressure or force sensing device is displayed and/or transmitted to the controller. The display can be undertaken by means of LEDs, especially flashing of same, or on a screen. The controller can also transmit the information regarding the filling level to a central location. The service personnel will empty the receiving container according to the display or the information being received at the central location.

### BRIEF DESCRIPTION OF THE DRAWINGS

Embodiments of the invention will now be described below with reference to the drawings. These are not necessarily intended to represent the embodiments to scale; on the contrary, the drawings are executed in schematic and/or slightly distorted form, where useful for explanation. With regard to additions to the teachings directly recognizable from the drawings, attention is drawn to the relevant prior art. It should be borne in mind here that many modifications and changes relating to the form and detail of an embodiment can be made without departing from the general concept of the invention. The features of the invention which are disclosed in the description, in the drawings and in the claims may be essential for the development of the invention, both individually and in any desired combination. Moreover, all combinations of at least two of the features disclosed in the description, in the drawings and/or in the claims fall within the scope of the invention. The general concept of the invention is not limited to the exact form or detail of the preferred embodiments shown and described below, nor is it limited to subject matter which would be restricted in comparison with the subject matter claimed in the claims. In the case of specified dimensioning ranges, the intention is also to disclose values lying within the limits mentioned as limit values and to allow for them to be used and claimed in any way. For the sake of simplicity, the same reference signs are used below for identical or similar parts or parts with identical or similar functions.

Further advantages, features and details of the invention will become apparent from the following description of the preferred embodiments and with reference to the drawings, in which

FIG. 1 shows an exemplary embodiment of a hygiene station for human hand hygiene;

FIG. 2 shows an exemplary embodiment of a compressing and shredding device according to the invention in an isometric view;

FIG. 3 shows the exemplary embodiment of FIG. 2 without a receiving container and with the insertion opening released;

FIG. 4 shows the exemplary embodiment of FIG. 2 without a receiving container and with the insertion opening closed;

FIG. 5 shows the exemplary embodiment of FIG. 3 in a top view;

FIG. 6 shows another exemplary embodiment of a cover element and a drive unit in a side view;

FIG. 7 shows a compressing and/or shredding unit with a pressing device in a first end position;

FIG. 8 shows a detail from FIG. 7;

FIG. 9 shows a compressing and/or shredding unit with a pressing device in a second end position;

FIG. 10 shows a detail from FIG. 9;

FIG. 11 shows a compressing and/or shredding unit with a cover element consisting of louvers;

FIG. 12 shows a compressing and/or shredding unit with three drive units;

FIG. 13 shows a compressing and/or shredding unit with three drive units; and

FIG. 14 shows a compressing and/or shredding unit in a view from below.

### DETAILED DESCRIPTION

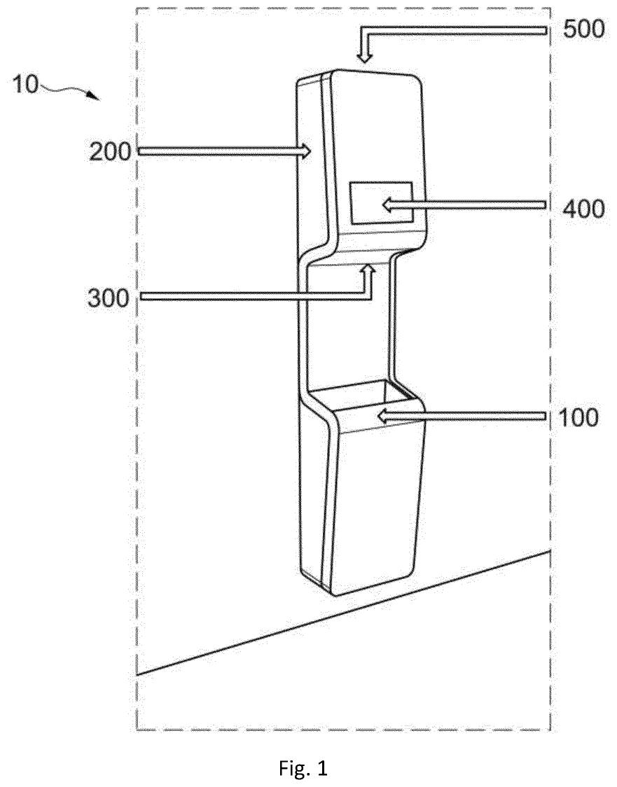

FIG. 1 shows an exemplary embodiment of a hygiene station for human hand hygiene 10.

The hygiene station 10 has a compressing and/or shredding device 100 according to the invention.

Moreover, the hygiene station 10 has a hand towel dispensing device 200.

In addition, a disinfectant dispensing device 300 is furthermore part of the hygiene station 10.

Furthermore, a display and input device 400 and a room fragrance emission device 500 are elements of the hygiene station 10.

The hygiene station 10 is mounted on a wall in FIG. 1, with the hygiene station 10 being electrically supplied directly via the building power supply. The hygiene station 10 may also be designed, however, as a mobile hygiene station, i.e. free-standing, and then has a sufficiently long electrical line, such as a power cable, with which it can be connected to a power supply or a generator.

Additional connection lines, supply lines or drains, such as a drain duct for the used paper hand towels, are not needed and are also not provided.

The hygiene station 10 is thus what is referred to as a stand-alone system, which is completely self-sufficient except for the power supply.

In principle, it would also be possible to provide the power supply in the form of a rechargeable battery or a battery. However, this is not necessary per se, as there is in principle also a power connection at the usual installation locations, such as a toilet (e.g. in a restaurant, a motorway rest area, a train station, etc.).

The disinfectant dispensing device 300 is arranged below the hand towel dispensing device 200 such that disinfectant can be dispensed into a user's hands held under the disinfectant dispensing device 300.

The display and input device 400 is arranged at approximately eye level of a user on the front side, i.e. on the outer surface opposite the installation side of the hygiene station 10. The display and input device 50 can display e.g. advertising or a proposal for carrying out the hand hygiene to a user for the duration of their hand hygiene. In addition, the user can use the display and input device 400, for example, for portioning the amount of disinfectant dispensed by the disinfectant dispensing device 300 and/or for specifying the number of hand towels dispensed by the hand towel dispensing device 200 for drying their hands. Furthermore, the user can use the display and input device 400, for example, to enter an evaluation of their satisfaction regarding the state and the equipment of the sanitary facility, in the surroundings of which the hygiene station is set up or is mounted.

The room fragrance emission device 500 is arranged above the hand towel dispensing device 200 such that it can supply or fill the site at which the hygiene station 10 is set up with a room fragrance filling the room as far as possible. The room fragrance emission can be carried out either at specified intervals or via a sensor which is assigned to the room fragrance emission device 500 and senses the number of users and/or their length of stay in the surroundings of the hygiene station 10 and, depending thereon, adjusts the room fragrance emission.

The compressing and/or shredding device 100 according to the invention into which the user can throw or feed in used hand towels is arranged below the disinfectant dispensing device 300.

The housing of the hand towel dispensing device 200 is located between the disinfectant dispensing device 300 and the room fragrance emission device 500, wherein the dispensing opening of the hand towel dispensing device 200 is arranged level with the dispensing of the disinfectant dispensing device 300 and opposite the insertion opening 116 of the compressing and/or shredding device 100.

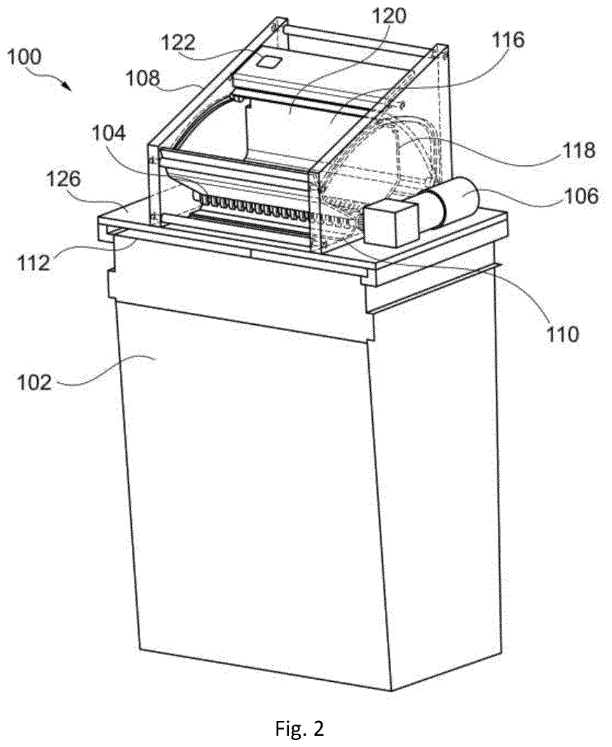

An exemplary embodiment of a compressing and/or shredding device 100 according to the invention is shown in FIG. 2 in an isometric view and comprises a receiving container 102, a compressing and/or shredding unit 104, a drive unit 106, a cover element 108, and cleaning elements 110.

The receiving container 102 comprises a feed opening 112 and an interior 114 (not visible).

The cover element 108 comprises a releasable and reclosable insertion opening 116, a funnel element 118, a lid element 120, a sensor 122, and a controller 124 (not shown).

In the exemplary embodiment shown in FIG. 2 of a compressing and/or shredding device 100, the cover element 108, the compressing and/or shredding unit 104, the drive unit 106, and the cleaning elements 110 are arranged on and fastened to a carrier unit 126 which is pushed along two rails on the top side of the receiving container 102 in such a manner that, in its end position, it completely covers the feed opening 112 of the receiving container, and therefore no compressed and shredded hand towels can fall out from the interior 114 of the receiving container 102 after the maximum receiving volume of the receiving container 102 is reached.

In the pushed-on end position of the carrier unit 126, the compressing and/or shredding unit 104 is located at least approximately in a central region above the receiving container 102.

The sensor 122 of the cover element 108 is arranged above the lid element 120 in such a way that it can sense the feed-in desire, i.e. an approaching hand with a used hand towel, and then sends a signal to the controller 124. The controller 124 then firstly activates the lid element 120, which releases the insertion opening 116, and secondly the drive unit 106, which drives the rollers or rolls 128 of the compressing and/or shredding unit 104.

As soon as the insertion opening 116 has been released from the lid element 120, the user can dispose of, or throw in, the used hand towel into the insertion opening 116.

The used hand towel is then fed via the funnel element 118 to the compressing and/or shredding unit 104, which compresses, shreds and conveys the hand towel in the direction of the interior 114 of the receiving container.

The compressed and shredded residues of the used hand towel, which adhere to the rollers 128 by the static charging as a result of the compressing and shredding process or by the moisture content contained in the used hand towel, are stripped off from the cleaning elements 110 on the underside of the rollers 128 in such a manner that they drop into the interior 114 of the receiving container 102.

After a specified interval of time or after a further signal from the sensor 122, the controller activates the drive module (not shown) of the lid element 120 so that the lid element 120 closes the insertion opening 116 again.

In a further exemplary embodiment of the cover element 108, the lid element 120 can additionally or alternatively be manually pushed on by a user and closed again after insertion of the used hand towel. For this purpose, a handling element is formed in the region of the front edge of the lid element 120 facing upward, which the user can grasp to displace the lid element 120. The lid element 120 can be held in the closed position by springs. The user then has to move the lid element 120 counter to the spring force in order to release the insertion opening 116. Releasing the lid element 120 causes the latter to spring back into the closure position because of the spring force and to thus close the insertion opening 116 again.

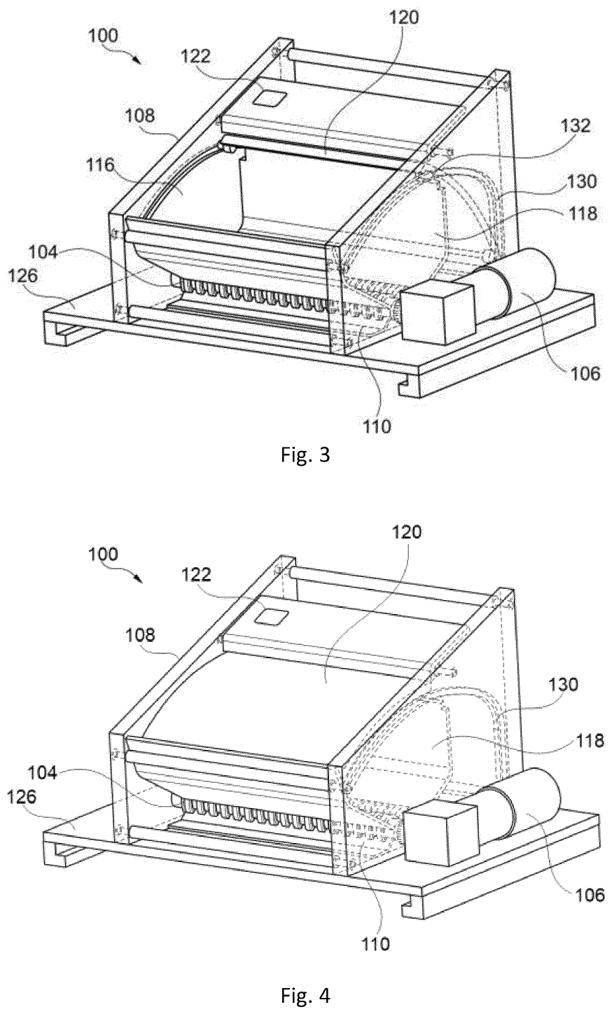

FIG. 3 and FIG. 4 show the compressing and/or shredding device 100 from FIG. 1 without a receiving container 102.

In FIG. 3, the lid element 120 is moved rearward and thus releases the insertion opening 116, while in FIG. 4 the lid element 120 closes the insertion opening 116.

A guide rail 130 along which the lid element 120 is movable is in each case attached on the inside of the side walls of the cover element 108. The lid element 120 in each case has a rolling element 132 level with its front edge and its rear edge on both sides. The rolling elements 132 engage in the respective guide rails 130 and enable the lid element 120 to be pushed or to slide along the guide rails 130.

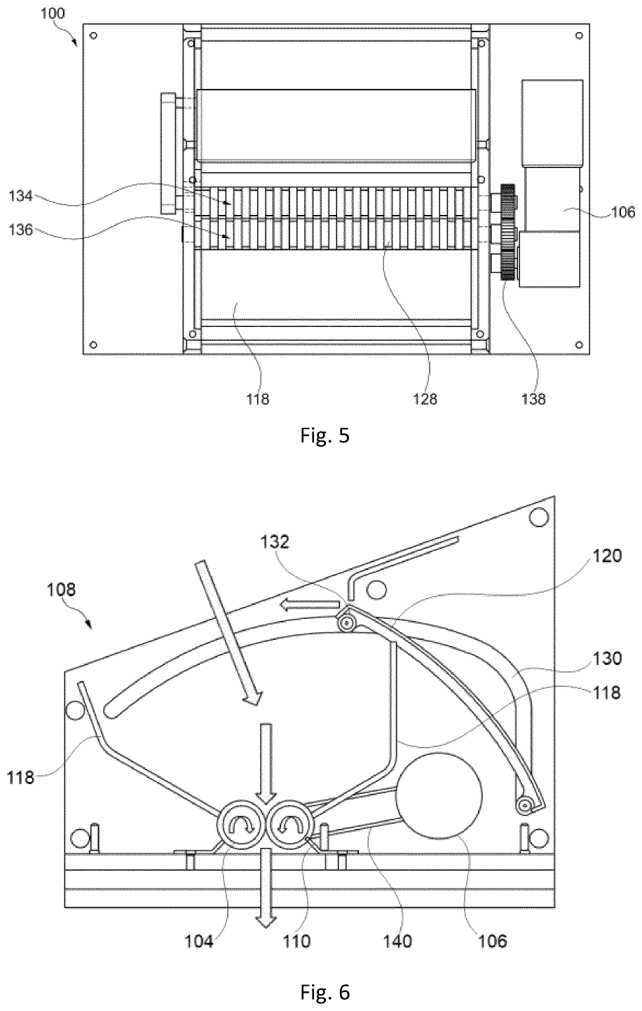

FIG. 5 shows the top view of the compressing and shredding device according to the invention from FIG. 2.

The configuration of the rollers 128 which have rings or rolls 134 equidistantly spaced apart in the longitudinal direction can be seen in the top view. The rings 134 can have been turned from a roller 128 with an original diameter corresponding to the diameter of the rings 134, and therefore the respective roller 128 and its rings 134 are integral. However, the rings 134 may also have been pushed onto the respective roller 128 and have been fastened at a predetermined position.

The equidistant spacing of the rings 134 along the longitudinal axis of the rollers 128 results in the formation of gaps 136 between each two rings 134.

The two rollers 128 in FIG. 5 are arranged in such a manner that the rings 134 in each case engage in the gaps 136 of the opposite roller 128 without the opposite roller 128 or its rings 134 being touched.

Advantageously, the depth of engagement of the rings 134 in the gaps 136 is adjustable such that the compressing and/or shredding unit 104 can be adjusted to the composition of the hand towels to be compressed and to be shredded.

Furthermore, it can be seen from FIG. 5 that the drive unit 106 drives the rollers 128 via a gearwheel arrangement 138 in such a way that the rollers rotate in opposite directions about their longitudinal axes.

It can also be seen that the formation of the funnel 118 over the entire width of the compressing and/or shredding unit 104 ensures that all of the used hand towels which have been thrown in are fed to the compressing and/or shredding unit 104 without individual used hand towels passing into a dead region and thus not being able to pass in compressed and shredded form into the receiving container 102.

In FIG. 6, a further exemplary embodiment of a cover element 108 and a drive unit is shown in a side view. In this alternative exemplary embodiment, the rollers 128 are not driven by a gearwheel arrangement 138, but rather by a belt 140.

The side view makes it furthermore possible to see the profile of the cleaning elements 110 which have a first portion for fastening to the carrier unit 126 and a second portion which is positioned or angled at a certain angle to the first portion and thus faces a lower part of the rollers 128.

The edge of a cleaning element 110 facing the respective roller 128 may be formed either in such a manner that it has a continuous profile along the longitudinal axis at a small distance from the rings 134.

Or, however, the edge is designed as a negative of the outer contour along the longitudinal axis of the respective roller 134 and accordingly engages in the gaps 136 in a lower region of the rollers with equidistant and uniform projections manufactured along the edge. This achieves a better cleaning result for the rollers 128.

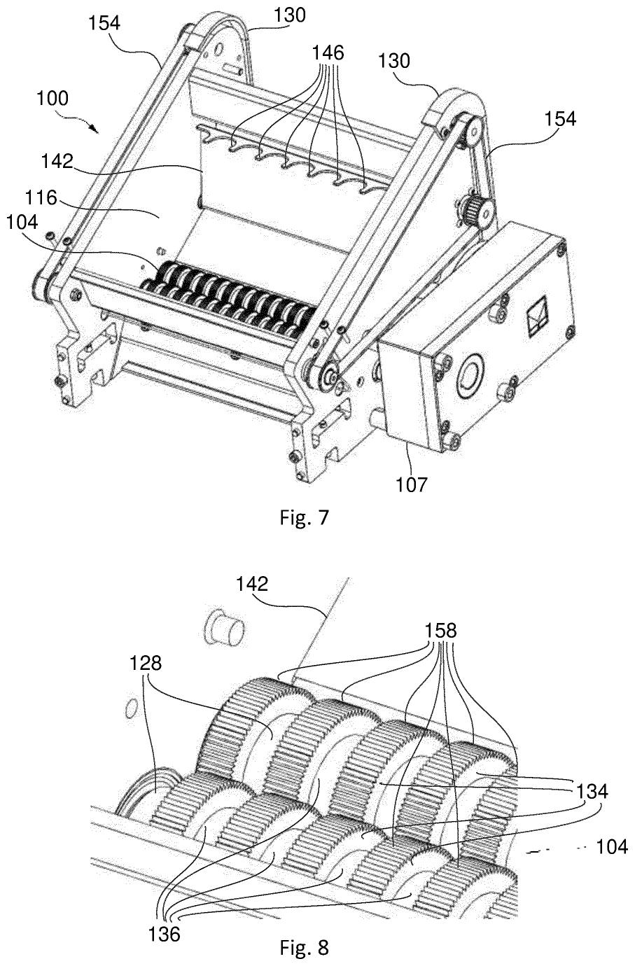

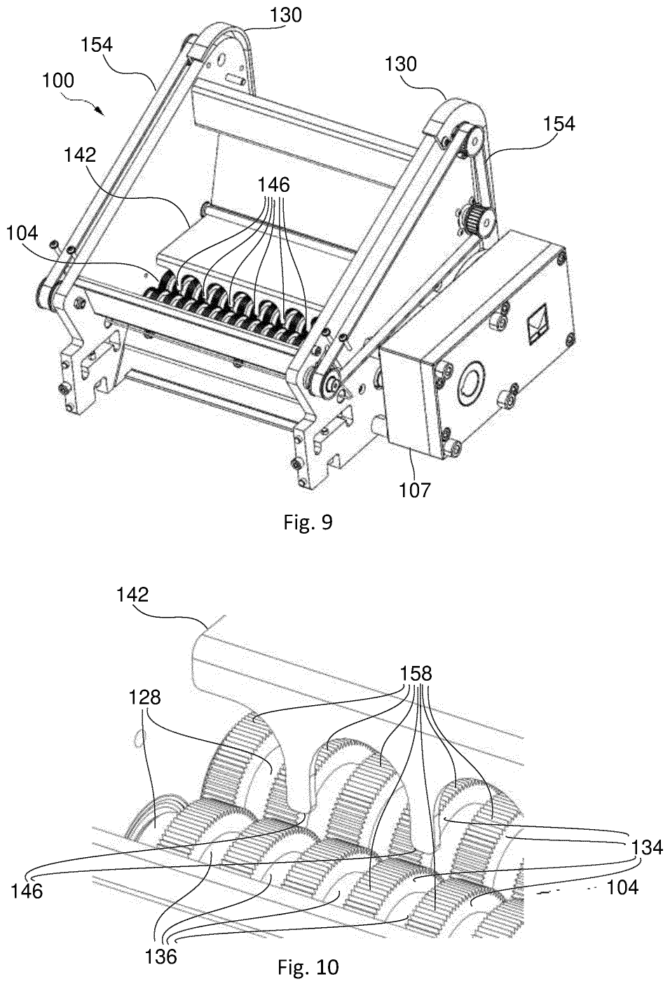

FIGS. 7 to 10 show a compressing and/or shredding unit 104 together with a pressing device 142. The pressing device 142 is movable by a pressing drive unit 144 shown in FIGS. 12 to 14 between two end positions at a different distance from the compressing and/or shredding unit 104. The drive is transmitted via a pressing transmission 145. When the insertion opening 116 of the lid element 120 is released, the pressing device 142 is simultaneously in the first end position shown in FIGS. 7 and 8 at a large distance from the rollers 128. The large distance is selected in such a manner that the region between the insertion opening 116 and the rollers 128 is free and hand towels can pass to the rollers 128 unhindered through the insertion opening 116. If the insertion opening 116 is closed by the lid element 120 after at least one hand towel is inserted, the pressing device 142 is moved into the second end position shown in FIGS. 9 and 10, at which the distance from the rollers 128 is so small that hand towels in the region between the rollers 128 are pressed against the compressing and/or shredding unit. At the same time, the rollers 128 are set into opposed rotation by the shredding drive unit 106 via a shredding transmission 107.

FIGS. 8 and 10 clearly show the rollers 128 with the rings 134 and the gaps 136 between the rings 134. So that material of the hand towels is readily drawn into the clearances of the gaps 136 and conveyed through them toward the receiving container, the rings 134 have a rough surface radially on the outside. In the illustrated embodiment, the rough surface is designed as a knurling in the form of furrows 158, wherein the furrows 158 extend along the axes of the rollers 128.

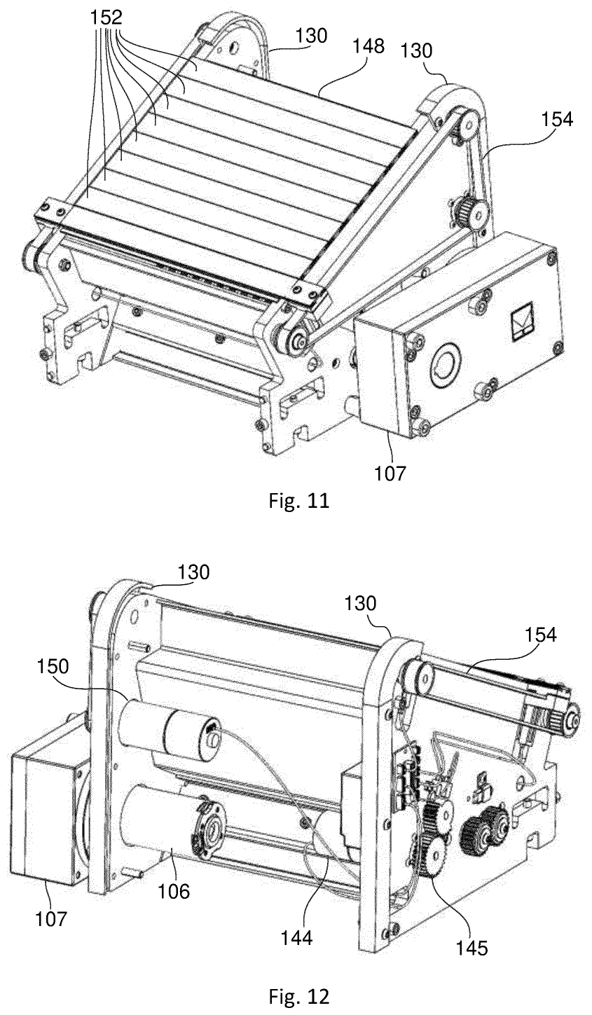

FIG. 11 shows a lid element 148 which comprises louvers 152, which are pivotably connected to adjacent louvers 152 on longitudinal sides and guided in guide rails 130 on the narrow sides. In the embodiment shown, the guide rails 130 extend in a first region at the insertion opening 116 in a direction which forms an angle of less than 45° with respect to a horizontal plane, wherein in particular lower ends of the guide rails 130 face the position of a person using the hygiene station. In a second region of the guide rails 130, the latter preferably extend substantially vertically. The two regions of each guide rail 130 are connected to each other via a region of curvature. When the insertion opening 116 is closed, the louvers 152 are located in the first region of the guide rails 130 and, when the insertion opening 116 is released, said louvers are located in the second region. The louvers 152 are moved by a lid drive unit 150 in the guide rails 130, wherein the transmission of drive from the lid drive unit 150 to the louvers 152 takes place via drive belts 154 and two drivers 156 fastened to the drive belts 154 and to a louver 152.

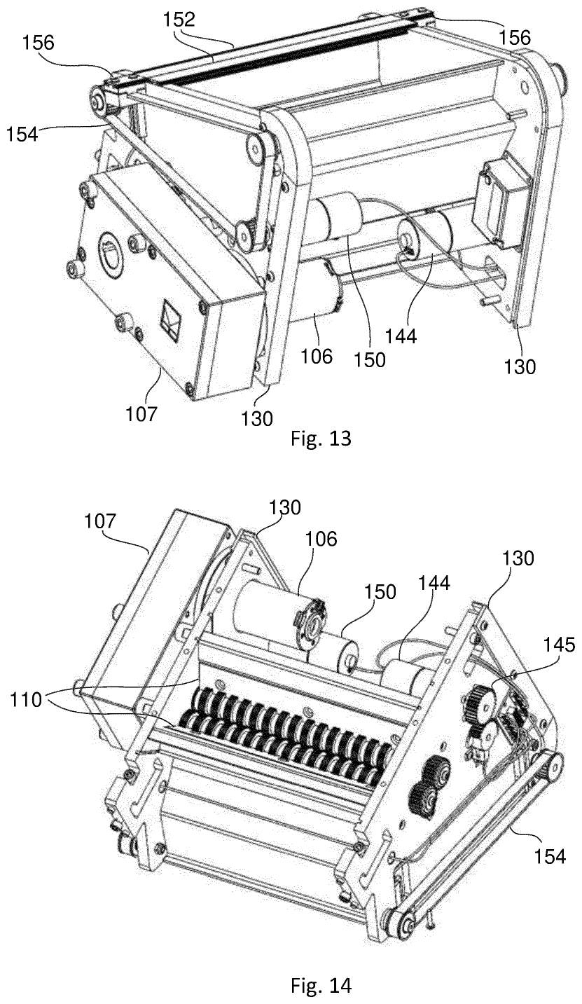

FIGS. 7 and 9 do not show the louvers 152. FIG. 13 shows just one louver 152. The cleaning elements 110 can readily be seen in FIG. 14.

1. A compressing and shredding device for integration in a hygiene station for human hand hygiene, said device is adapted to compress and shred hand towels, the compressing and shredding device comprises:
a receiving container with a feed opening and an interior for receiving compressed and shredded hand towels;
a compressing and/or shredding unit for compressing and shredding hand towels, which is arranged at the feed opening of the receiving container; and
a shredding drive unit for driving the compressing and/or shredding unit,
wherein the compressing and/or shredding unit comprises at least two rollers which are arranged parallel to one another and rotate in opposite directions about respective axes.

2. The compressing and shredding device as claimed in claim 1, wherein the rollers have a multiplicity of revolving rings and/or grooves.

3. The compressing and shredding device as claimed in claim 2, wherein the rings are uniform and are arranged spaced equidistantly apart.

4. The compressing and shredding device as claimed in claim 2, wherein the rings are formed integrally on the respective roller.

5. The compressing and shredding device as claimed in claim 2, wherein the rings of the rollers are arranged such that in each case one of the rings of one of the rollers is opposite a gap between two of the rings of the other of the rollers.

6. The compressing and shredding device as claimed in claim 2, wherein the rings of the rollers intermesh.

7. The compressing and shredding device as claimed in claim 2, wherein the rings have a rough surface radially on an outside.

8. The compressing and shredding device as claimed in claim 1, further comprising a cover element with a releasable and reclosable insertion opening that covers the feed opening of the collecting container and accommodates the compressing and/or shredding unit.

9. The compressing and shredding device as claimed in claim 8, wherein the cover element for releasing and reclosing the insertion opening comprises a lid and a lid drive unit.

10. The compressing and shredding device as claimed in claim 8, wherein the cover element has a funnel element arranged below the insertion opening and is configured to conduct inserted hand towels to the compressing and/or shredding unit.

11. An arrangement comprising the compressing and shredding device as claimed in claim 1, and a pressing device, which is movable by a pressing drive unit between two end positions at a differing distance from the compressing and/or shredding unit such that hand towels are pushable onto the compressing and/or shredding unit.

12. The arrangement as claimed in claim 11, wherein the pressing device has at least one projection, which is movable in a movement of the pressing device to the compressing and/or shredding unit toward a region between two of the rollers.

13. The arrangement as claimed in claim 11, wherein the pressing device is pivotable about a pressing axis which is aligned parallel to axes of the rollers.

14. The compressing and shredding device as claimed in claim 1, further comprising cleaning elements on a side of the compressing and/or shredding unit which faces the interior of the receiving container, the cleaning elements freeing the compressing and/or shredding unit from adhering residues of the hand towels.

15. The compressing and shredding device as claimed in claim 11, further comprising a cover element with a releasable and reclosable insertion opening that covers the feed opening of the collecting container and accommodates the compressing and/or shredding unit, a sensor, and a controller connected to the sensor, the controller being configured for releasing and reclosing the insertion opening and, depending thereon, for rotating the rollers and moving the pressing device, wherein the sensor is arranged on an outer surface of the device.

16. The compressing and shredding device as claimed in claim 7, wherein the rough surface comprises at least one of a knurling or furrows which extend along axes of the rollers.

17. The compressing and shredding device as claimed in claim 8, wherein the lid is constructed from louvers which are pivotably connected to adjacent ones of the louvers on longitudinal sides and guided in guide rails on narrow sides thereof.

18. The compressing and shredding device as claimed in claim 1, further comprising a pressure or force sensor arranged on the receiving container to sense and a filling level of material in the receiving container.
